(19) United States
(12) Patent Application Publication
(10) Pub. No.: US 2005/0157899 A1
(43) Pub. Date: Jul. 21, 2005

(54) Molded earpiece assembly for auditory testing

(76) Inventors: Gabriel Raviv, Glenview, IL (US); Thomas F. Hilbert, Fond du Lac, WI (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/870,087

(22) Filed: Jun. 17, 2004

Related U.S. Application Data
(60) Provisional application No. 60/536,700, filed on Jan. 15, 2004.

(51) Int. Cl. H04R 29/00

(52) U.S. Cl. 381/322; 381/60

(57) ABSTRACT

An earpiece for auditory testing. The earpiece includes a baffle and an enclosure defining a chamber. The ear piece is sized to fit over the pinna of a patient and to secure and seal to the patient's head. The baffle is designed to provide flexibility to ensure a proper fit and seal of the earpiece to the patient, and to provide sufficient volume within the chamber to not interfere with the pinna. The earpiece may be of single piece or multiple piece construction.

### CROSS-REFERENCE TO RELATED APPLICATION

This patent claims benefit of provisional patent application Ser. No. 60/536,700, filed Jan. 15, 2004, the disclosure of which is hereby expressly incorporated herein by reference.

### TECHNICAL FIELD

The present invention relates to earpieces for auditory testing, and more particularly to earpieces that provide for an enhanced sound delivery chamber.

### BACKGROUND

Earpieces for auditory testing of various types are known in the art. Such devices are typically used in clinics or hospitals to conduct hearing screening tests on individuals. While adults may undergo hearing tests, it is especially critical with infants to determine, at an early age, whether or not any hearing impairments exist. Early detection of a child's hearing problem can be particularly advantageous because the problems and costs associated with treating the identified problem can be minimized.

During the evolution of screening for hearing-related deficiencies, several devices have been developed to introduce sound into a patient's ear and to detect a patient's response to that sound. The response may occur as a result of the characteristics of the introduced sound and the conditions inside the ear, the vibration transmission mechanism of the ear and the neural connections of the ear. After detection of the patient's response, the response is then analyzed to determine the patient's hearing capabilities and limitations.

Existing earpieces for hearing testing have some inherent disadvantages. For example, many do not effectively block noise that can interfere with the stimulus and with the patient's response to the stimulus. This interference may result in prolonged testing times and flawed results making accurate analysis difficult.

Yet another disadvantage with existing earpieces is that they may be difficult to handle and are often difficult to use with infants. For example, single walled earpieces with sealing flanges may require the operator to use both hands to apply and seal the earpiece to the infant. It is often desirable to have one hand free to steady the infant's head while using the other hand to secure the earpiece. However, it may be necessary to use both hands: one to hold the earpiece and the other to press the flange in place. When removing the earpiece from the infant, the operator must release the flange, either by lifting an edge of the flange or by locating and pulling a tab formed on the flange.

Another disadvantage of existing earpieces is that they are expensive to manufacture. Minimization of manufacturing cost is important because, according to accepted general medical practices, the earpieces must be disposed of as medical waste after use.

### BRIEF DESCRIPTION OF THE DRAWINGS

FIG. 1 is a top perspective view of an earpiece in accordance with a described embodiment.

FIG. 2 is a first bottom perspective view of the earpiece illustrated in FIG. 1.

FIG. 3 is a second bottom perspective view of the earpiece illustrated in FIG. 1.

FIG. 4 is a top view of the earpiece illustrated in FIG. 1.

FIG. 5 is a side view of the earpiece illustrated in FIG. 1.

FIG. 6 is a bottom view of the earpiece illustrated in FIG. 1.

FIG. 7 is a cross-section view taken along line 7-7 of FIG. 4.

FIG. 8 is a partial cross-section view of the portion 8-8 illustrated in FIG. 5.

FIG. 9 is a partial cross-section view of the portion 9-9 illustrated in FIG. 7.

FIG. 10 is a partial cross-section view of the portion 10-10 illustrated in FIG. 7.

FIG. 11 front perspective of an earpiece in accordance with a described embodiment at an intermediate stage of manufacture.

FIG. 12 is a partial bottom perspective of the earpiece illustrated in FIG. 11.

FIG. 13 is a front view of the earpiece illustrated in FIG. 11.

FIG. 14 is a first side view of the earpiece illustrated in FIG. 11.

FIG. 15 is a second side view of the earpiece illustrated in FIG. 11.

FIG. 16 is a cross-section view taken along line 16-16 of FIG. 14.

FIG. 17 is a cross-section view taken along line 17-17 of FIG. 14.

FIG. 18 is a partial cross-section view of the portion 18-18 illustrated in FIG. 17.

FIG. 19 is a partial cross-section view of the portion 19-19 illustrated in FIG. 17.

### DETAILED DESCRIPTION

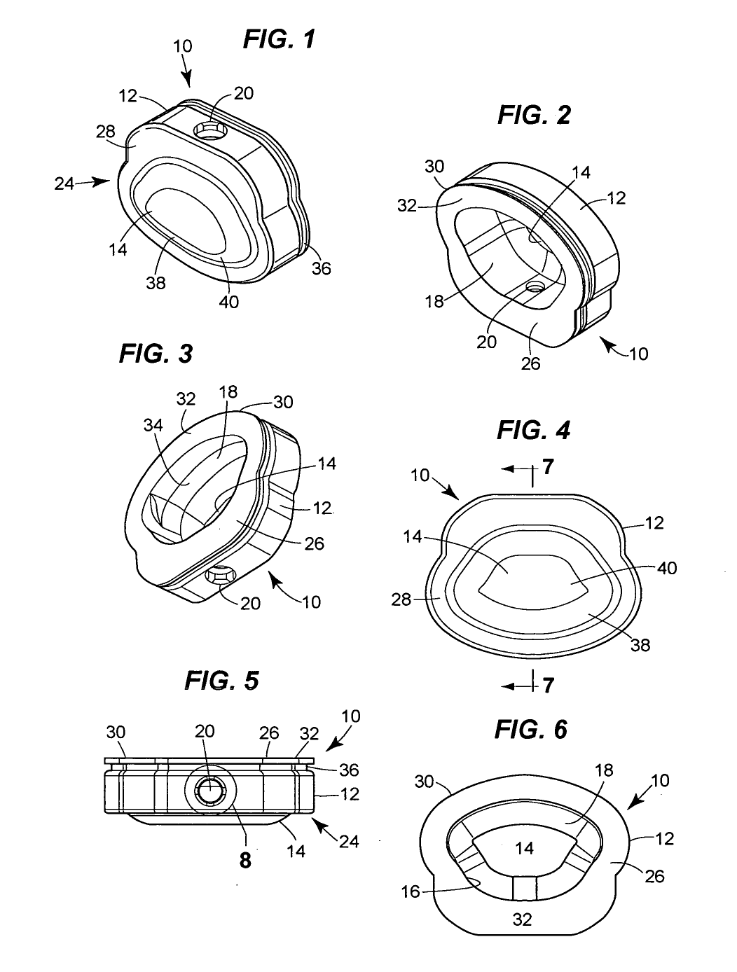

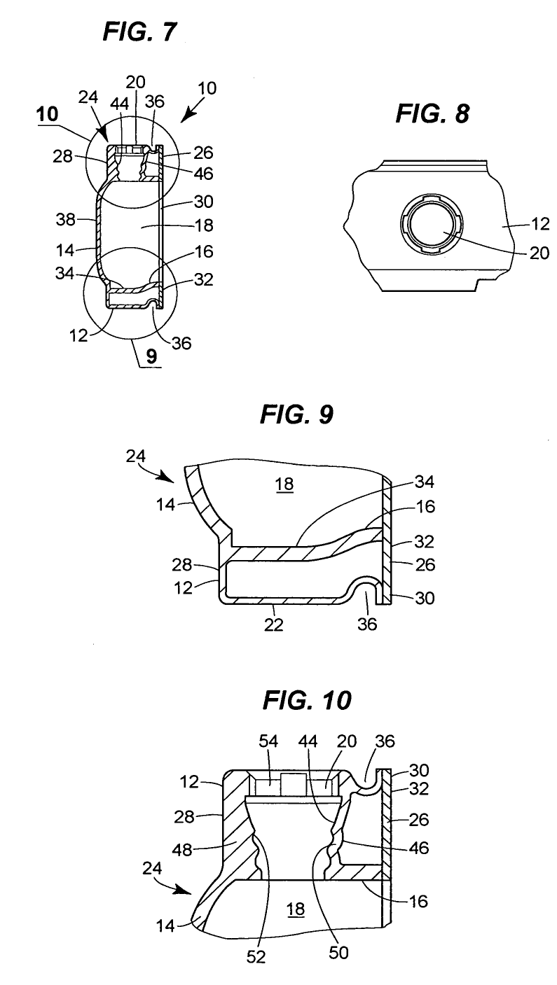

Referring to FIGS. 1-10, an earpiece 10 includes a baffle 12 and an enclosure 14 formed with the baffle 12 along an inner wall 16 of the baffle. The baffle 12 and the enclosure 14 define a chamber 18. The baffle 12 is formed to include a port 20 extending between an outer wall 22 and an inner wall 16 of the baffle 12 to allow a transducer or other suitable audible stimulus source to be coupled to the chamber 18. The baffle 12 includes a bottom wall 26 and a top wall 28. The top wall 28 is formed with the outer wall 22 and the inner wall 16 and encloses the top portion of the baffle 12. The bottom wall 26 is formed as a separate, bottom member 30 that is secured to the baffle 12 to enclose the bottom portion of the baffle 12. The bottom member 30 may be secured to the baffle 12 by adhesive, mechanical coupling, welding or any suitable method for joining the bottom member 30 to the baffle 12. For example, hot melt adhesive may be used to join the bottom member 30 to the top portion 24 of the earpiece 10. Although, other adhesive types such as heat activated, chemical or catalyst activated, pressure sensitive, ultra-sonic activated, and the like may be used as the particular adhesive used to secure the bottom member 30 is not critical so long as the bottom member 30 is securely joined to the top portion 24 so as not to separate during use.

The bottom wall 26 may include an adhesive coating 31, layer or appliqué on a bottom surface 32 to allow the earpiece to be secured to the patient as will be discussed below. The adhesive coating 31 will generally be a different adhesive than the one used to secure the bottom member 30, but development of a suitable adhesive for both purposes may occur. A suitable adhesive for the adhesive coating 31 is sold by Minnesota Mining and Manufacturing Co. under the product designation 3M 9877, although hydrogel, hydrocolloid, and other suitable medical adhesives may be used. Preferrably, the adhesive provides a sufficiently long shelf life to allow an inventor of earpieces 10 to be maintained at a hospital or testing facility.

The adhesive coating 31 may also be formed integrally with an electrode (not depicted) as shown and described in commonly assigned U.S. patent application Ser. No. 09/748,800, filed Dec. 22, 2000 and entitled “Earpiece for Auditory Testing,” the disclosure of which is hereby expressly incorporated herein by reference.

The earpiece 10, i.e., the baffle 12 and enclosure 14 and the bottom member 30, may be formed from a suitable flexible polymer material such as polyvinylchloride (PVC), polyester, acrylic, silicone or the like. The bottom member 30, however, may be made from a material different than that used to form the outer wall 22, inner wall 16, top wall 28 and enclosure 14, i.e., the top portion 24. In one embodiment, for example, the top portion 24 may be formed from PVC while the bottom member 30 is formed from polyester.

The chamber 18 is sized to entirely envelope the pinna of a patient, and it will be appreciated that the earpiece 10 may be made in several sizes to accommodate differing pinna sizes of patients from infancy to adulthood. The chamber 18 may have a contoured shape, as show in FIGS. 1-10 generally corresponding to the shape of the pinna, but it may alternatively be circular, elliptical, or otherwise shaped so as to permit the earpiece 10 to be disposed over the pinna and to allow the bottom surface 32 to contact the patient's head. The inner wall 16 may be formed with a relief 34 (best seen in FIGS. 6 and 9) to provide additional volume within the chamber 18 to accommodate the pinna, although it is not required to form the inner wall 16 with the relief 34.

In use, the earpiece 10 is fitted over the pinna of the patient and the bottom surface 32 contacts the skin of the patient surrounding the ear. As described, the bottom surface 32 may include an adhesive to allow the earpiece to be secured to the patient. To ensure the earpiece is acoustically sealed to the patient's head, it may be necessary for the earpiece 10 to flex so that the bottom surface 32 seals to the patient's head around its entire periphery. In this regard, as discussed above, the earpiece 10 may be formed from one or more generally flexible materials, such as a flexible polymer. The hollow structure of the baffle 12 enhances the flexibility of the earpiece 10 as compared to a thick single wall or foam wall baffle structure. As is best seen in FIGS. 6 and 9, the outer wall 22 may be formed with a thinner wall section than the inner wall 16 and the top wall 28, and both the outer wall 22 and inner wall 16 overall may be thinner and more flexible than if a single wall structure was used yet provide superior noise immunity. Moreover, because the bottom wall 26 is supported at two places by the inner wall 16 and the outer wall 28, it too may be made substantially more flexible than if a single cantilevered flange is used. This structure allows the baffle 12 to flex more easily so that the bottom surface 32 may adapt and seal to the patient's head. Optionally, to add flexibility, the outer wall 24 may be formed with a relief 36. The relief 36 provides an added degree of flexibility for the bottom member 30 about its outer periphery so that the bottom surface 32 may easily contact and seal to the patient's head.

To further add volume to the chamber 18, the enclosure 14 is shown to have an outwardly curving, convex shape. The enclosure 14 need not be convex, but may be substantially flat, flat or concave. The outer surface 38 of the enclosure 14 provides a convenient location for providing an indication 40 of the product supplier.

Referring now to FIGS. 1-10, and particularly FIG. 10, the port 20 is formed through the outer wall 22 and the inner wall 16 and includes a port surface 44 defined by a wall member 46 extending from the outer wall 22 to the inner wall 16. As illustrated, the wall member 46 may include a portion 48 formed integral with the top wall 28 and a second portion 50 enclosing the port 20 and defining the port surface 44. The port surface 44 may be formed with a variety of formations to designed to grip and secure a probe or transducer inserted into the port 20 and to seal the transducer within the port 20 against noise infiltration. As shown, the port surface 44 includes scallop formations 52 that may engage a transducer inserted within the port 20, either be engaging corresponding structures formed on the transducer or simply by interferingly engaging an outer surface of the transducer to both secure and seal the transducer within the port 20. The port surface 44 may further be formed to include lug surfaces 54. The lug surfaces 54 are adapted to engage corresponding surfaces on an outer surface of the transducer to prevent rotation of the transducer within the port 20 once inserted.

The port 20 may also be sized and configured to accept an adapter. Various adapter may then be produced to mate with corresponding probe/transducer configurations. An outer surface of the adapter would sealingly engage the port surface 44, while an inner surface of the adapter would sealingly engage an outer surface of the probe/transducer being used.

The earpiece 10 is easily handled and used. The baffle 12 provides sufficient structure about a periphery of the earpiece 10 to allow it to be grasped, positioned and pressed against the patients head to secure it thereto. At the same time, the baffle 12 is flexible, owing to the construction of the outer wall 22, the inner wall 16, the top wall 28 and the relief 36 to allow the bottom member 30 to flex and the bottom surface 32 to engage the patient's head. The bottom surface 32 provides a substantial area for application of adhesive to ensure that the earpiece 10 is securely attached to the patient and is sealed against noise infiltration. After testing, the earpiece 10 is easily removed by gasping the outer wall 22 and peeling away the earpiece 10 from the patient's head. Thus, the operator does not have to fumble with securing a sealing flange or with having to peel up an edge or tab portion of the sealing flange to release the earpiece from the patient.

The earpiece may be secured to the patient using one hand to hold the earpiece and the other to steady the patient's head. That is, the baffle 12 provides sufficient structure to be grasped by the operator, while supporting the bottom surface 32, so that the operator's other hand is free to steady the patient's head.

The baffle 12 including the baffle space 56 defined by the outer wall 22, inner wall 16, top wall 26 and bottom wall 28 provides noise immunity, while at the same time provides a flexible structure allowing the earpiece 1 0 to be secured and sealed to the patient's head. A corresponding single wall structure, to provide similar noise immunity capability, would be prohibitively thick and stiff. The enclosure 14 may have a thickness the same as, less than or greater than the thickness of any of the outer wall 22, inner wall 16, top wall 26 and bottom wall 28 to provide sufficient noise immunity while not inhibiting the flexibility of the baffle 12.

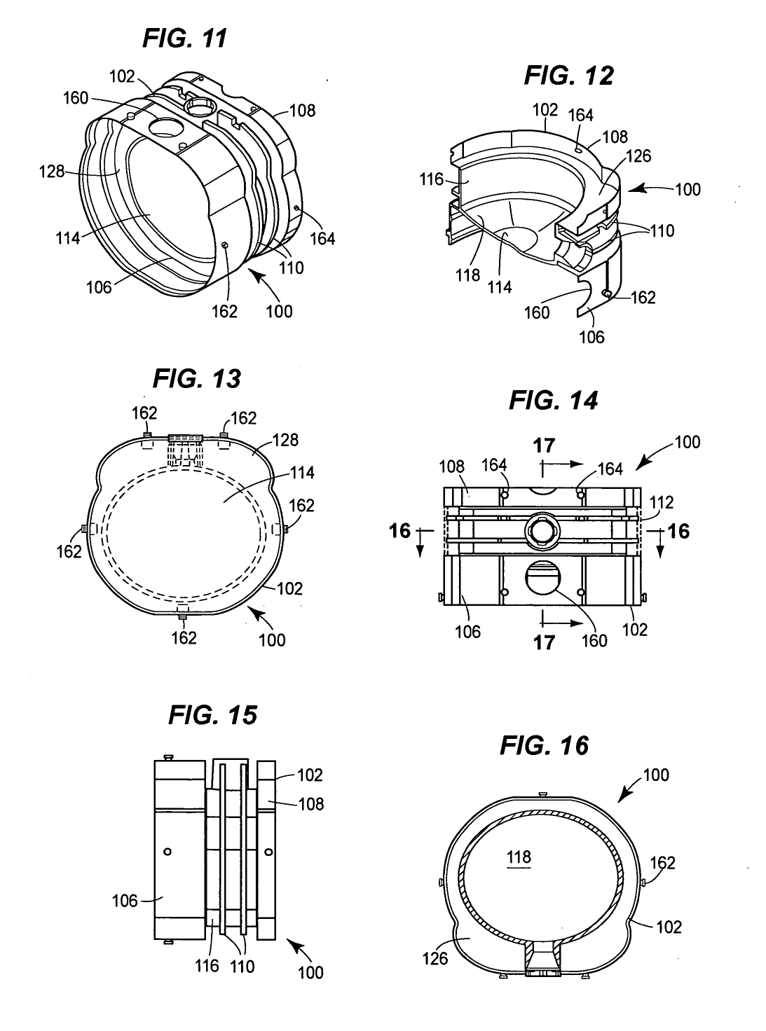

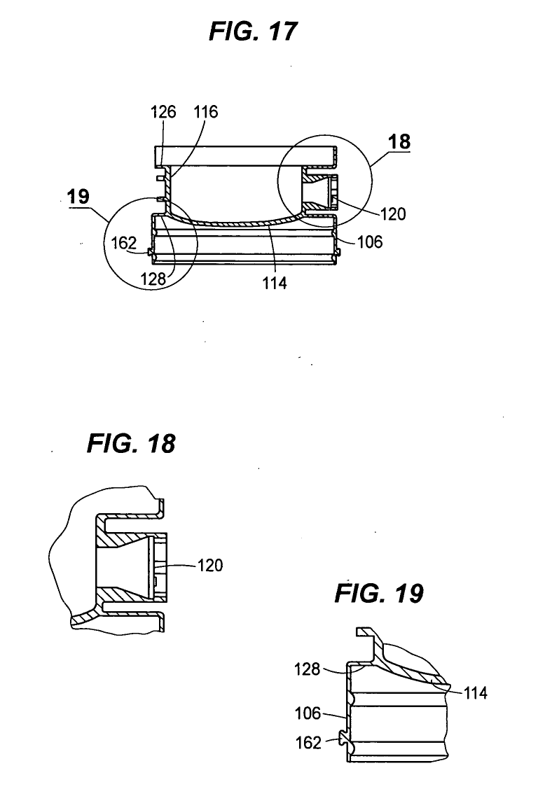

As described, the earpiece 10 is formed as two pieces, a top portion 24 including the outer wall 22, inner wall 16, top wall 28 and the enclosure 14 and a bottom member 30 including the bottom wall 26. The bottom member 30 is secured, for example by adhesive bonding, welding or mechanical joining, to the top portion. Referring now to FIGS. 11-18, an earpiece 100 may be formed, including a baffle 112 (shown in phantom) and an enclosure 114 defining a chamber 118 from a molded member 102. As shown, as molded, the molded member 102 includes the enclosure 114, the inner wall 116, the top wall 128, the bottom wall 126 and the port 120. The molded member also includes first circumferentially extending flange 106 and second circumferentially extending flange 108, and optionally may include one or more rib members 110 extending radially outwardly from the inner wall 116.

The first flange 106 is formed to include an aperture 160 and a plurality of locking post structures 162 disposed around the circumference of the first flange 106. The second flange 108 includes a plurality of locking apertures disposed at corresponding locations around the circumference of the second flange 108. To complete the earpiece 100, and form the baffle 112, the second flange 108 is fold upward. The first flange is then folded downward. The locking posts 162 are inserted through and lockingly engage the locking apertures 164 to secure the first flange 106 to the second flange 108 and to define the outer wall 122 of the baffle 112. The aperture 160 corresponds in size and location to the port 120 to provide access to the port 120.

The features of the embodiments of an earpiece 10 and an earpiece 100 may be interchange, and it should be understood that although all features of earpieces as described herein have not be described in the context of every embodiment, such features may be implemented in any of the embodiments, and such implementations would be within the scope of the invention.

A “disposables” kit for hearing testing may provide two earpieces 10/100 secured by the adhesive layer 31 to a backing paper that may further include instructions. The kit may alternatively include one or more pairs of adapters for coupling the earpieces to one or more different types of transducers. The disposables kit may contain additional items, such as instructions for use and sensor devices, such as tab electrodes. Thus, in a single stock keeping unit, a common-style ear phone that may be used with a wide range of different transducer devices is conveniently provided. It will be appreciate that the adapters may be made in different colors to allow easy identification of the particular adapter to use with a particular transducer.

Specific embodiments of methods and apparatus for the construction of earpieces for auditory testing have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. An earpiece for auditory testing comprising:
a baffle including an outer wall, an inner wall, a top wall and a bottom wall defining a baffle space;
an enclosure formed with the inner wall defining a chamber;
a port formed through the baffle extending from the outer wall to the inner wall, the port sized to receive a stimulus source; and
the baffle formed to include at least one flexibility enhancing feature.

2. The earpiece of claim 1, wherein the flexibility enhancing feature comprises a wall thickness of at least one of the outer wall, the inner wall, the top wall and the bottom wall being different than the wall thickness of at least another of the outer wall, the inner wall, the top wall and the bottom wall.

3. The earpiece of claim 1, wherein the flexibility enhancing feature comprises a relief formed in the outer wall.

4. The earpiece of claim 3, wherein the relief is formed adjacent to the bottom wall.

5. The earpiece of claim 1, wherein the bottom wall is secured to the earpiece.

6. The earpiece of claim 1, wherein the bottom wall is adhesively bonded to the earpiece.

7. The earpiece of claim 1, the port including a port surface, the port surface formed to include at least one stimulus source engaging feature.

8. The earpiece of claim 7, wherein the stimulus source engaging feature comprises a scallop surface formed in the port surface.

9. The earpiece of claim 7, wherein the stimulus source engaging feature comprises a tapered section of the port surface.

10. The earpiece of claim 7, wherein the stimulus source engaging feature comprises a lug member.

11. The earpiece of claim 1, wherein the inner wall includes an offset portion between the bottom wall and the top wall to increase a diameter of the chamber for placement over a patients ear.

12. A method of making an earpiece for auditory testing, the method comprising the steps of: forming a first earpiece member including a baffle portion having an inner wall, outer wall and a first baffle end wall; an enclosure secured to the inner wall; and a port extending through the baffle portion from the outer wall to the inner wall;
forming a second earpiece member including a second baffle end wall; securing the second earpiece member to the first earpiece member to enclose a baffle space defined by the inner wall, the outer wall, the first baffle end wall and the second baffle end wall.

13. A method of making an earpiece for auditory testing, the method comprising the steps of:
forming an earpiece intermediate member including a baffle inner wall, first and second baffle end walls, an enclosure, a port extending outwardly from the baffle inner wall and a first flange extending circumferentially from the first baffle end wall; and
folding the first flange to define a baffle outer wall; and securing the first flange in place.

14. The method of claim 13, wherein the earpiece intermediate member comprises a second flange extending circumferentially form the second baffle end wall, the method comprising:
folding the second flange to define the baffle outer wall and securing the first flange to the second flange.
